(19) United States
(12) Patent Application Publication
(10) Pub. No.: US 2012/0079336 A1
(43) Pub. Date: Mar. 29, 2012

(54) TECHNIQUES UTILIZING ARQ FEEDBACK FOR EFFICIENT TRANSMITTER BUFFER USAGE

(76) Inventor: Aran Bergman, Givatayim (IL)

(21) Appl. No.: 12/890,020

(22) Filed: Sep. 24, 2010

(51) Int. Cl. G08C 25/02; G06F 11/00

(52) U.S. Cl. 714/748; 714/E11.001

(57) ABSTRACT

An embodiment of the present invention provides an apparatus, comprising a base station with a transceiver operable to communicate with a mobile station (MS) in a wireless network and further adapted to provide ARQ Feedback to said MS enabling an efficient transmitter buffer usage by said transceiver sending its updated feedback any time and using a currently defined feedback IE to indicate which blocks arrived at said transceiver and which did not arrive yet or using a modified feedback IE.

### BACKGROUND

Wireless communications, including wireless networks, have become pervasive throughout society. Improvements in wireless communications are vital to increase their reliability and speed. Further, it would be beneficial to reduce required ARQ transmitter memory to support maximum throughput, even when errors occur while still avoiding unnecessary ARQ retransmissions.

Currently existing wireless techniques solve this problem by using an ARQ_ERROR_DETECTION_TIMEOUT timer in a receiver which prevents the receiver from sending NACKs on ARQ blocks still being retransmitted by the HARQ mechanism. However, this timer also prevents positive ACK on blocks that in the meantime arrived without errors to the receiver, thus requiring excessive transmit buffer in the transmitter.

Thus, a strong need exists for techniques utilizing ARQ feedback for efficient transmitter buffer usage.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the interacting components pertinent embodiments of the present invention;

FIG. 2 illustrates the results of preventing unnecessary ARQ retransmissions while the HARQ is still retransmitting a burst;

FIG. 3 depicts the ABS and AMS interaction according to embodiments of the present invention;

FIG. 4 illustrates one specific possible scenario when the HARQ retransmissions finally succeed according to embodiments of the present invention;

FIG. 5 illustrates one specific possible scenario when the HARQ retransmissions finally fails, and ARQ retransmissions are required according to embodiments of the present invention; and

FIG. 6 shows methods of operation of embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm, technique or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like), wireless wide are networks (WWAN) and Mesh networks.

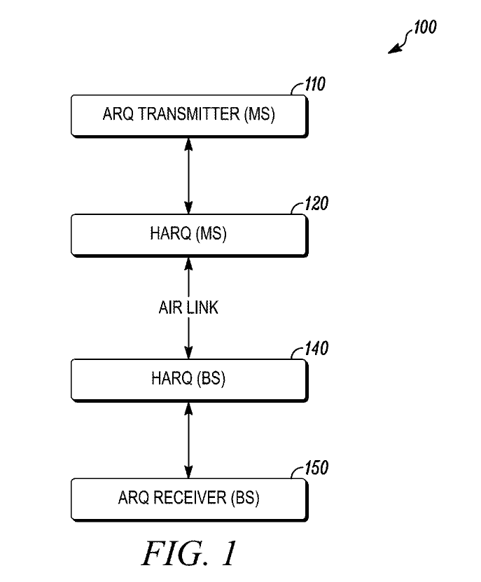

Embodiments of the present invention reduce required ARQ transmitter memory to support maximum throughput, even when errors occur while still avoiding unnecessary ARQ retransmissions. Looking at 100 of FIG. 1 is a depiction of the interacting components pertinent to the present invention. In existing wireless communication techniques, such as, but not limited to, those that conform to the Institute for Electronic and Electrical Engineering (IEEE) 802.16m and Long Term Evolution (LTE), all ARQ connections are unicast connections and all unicast transmissions are sent using a HARQ mechanism. The mobile stations (MS's) ARQ transmitter 110 submits ARQ blocks to the HARQ component 120 in the MS which in turn sends bursts containing these ARQ blocks. The HARQ components in the MS 110 and BS 140 exchange data bursts and feedback to try and send information from the MS 120 to the BS 140. When a burst is correctly received by the BS HARQ component 140, it is forwarded to the ARQ receiver in the BS 150. The ARQ receiver also generates feedback which is sent (through the HARQ components) to the ARQ transmitter. According to these ARQ feedbacks, the ARQ transmitter can update its state variables and perform retransmissions when necessary. It is understood that the aforementioned description pertains to ARQ transmissions originating from the AMS. That is—the AMS is sending data to the ABS. However, embodiments of the present invention reduce the ARQ transmitter buffer and it is thus applicable for a scenario in which the ABS is sending information to the AMS. It is depicted herein that the AMS is the transmitter because the AMS is usually more pressed for memory and reducing the memory requirements for the AMS is more important, but it is understood that embodiments of the present invention can be used just as well for reducing the buffer size in the ABS.

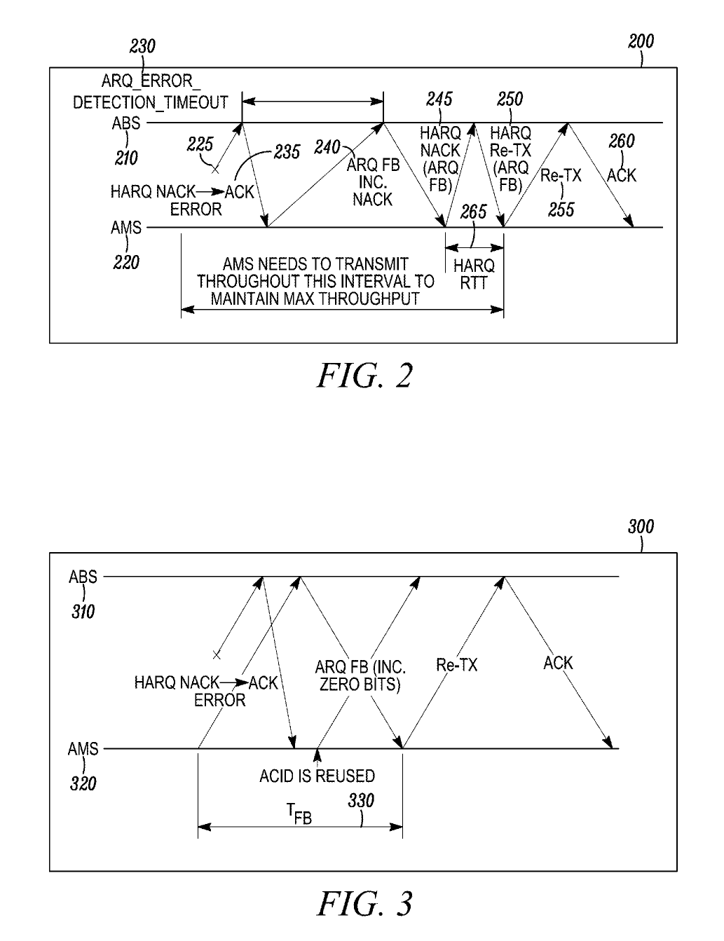

Using 802.16m draft 2 text, the scenarios in FIG. 2, shown generally as 200, would eventually occur. Sent by advance mobile station (AMS) 220, one ARQ block is dropped (or missing, or corrupt) 225 and the receiver stops sending feedbacks for ARQ_ERROR_DETECTION_TIMEOUT 230, since it is not allowed to send a NACK on the block yet and the current feedback format does not allow sending positive feedback on blocks after a missing block without NACK-ing the missing block. It is noted that it can send positive feedbacks on ARQ blocks prior to the missing block, but it cannot send feedback on blocks after it. The AMS HARQ transmitter does not resend the corrupt or missing block 225, since the AMS erroneously interpreted the feedback 235 sent from the ABS as a HARQ ACK, although a NACK was sent. In the depicted example—all other blocks are received correctly. (The implementation does not need to assume this.) After the timeout expires, the receiver sends ARQ feedback message 240 which includes a NACK on the missing block (along with ACK on all the correctly received blocks) which fails the first HARQ transmission 240, but succeeds on the second one 250). The transmitter receives NACK 250 and retransmits the block 255, this time the block is received correctly (i.e., one failure per block only in this example) and the ACK 260 for it is received after ARQ_RTT 265. Due to this, the transmitter needs to buffer all blocks between the missing block and the block which is transmitted right before correctly receiving the NACK for the missing block (for an aggregated time of ARQ_RTT+ARQ_ERROR_DETECTION_TIMEOUT+HARQ_RTT). This means that to maintain the maximum throughput, the transmitter must maintain a buffer of BW * (ARQ_RTT+ARQ_ERROR DETECTION TIMEOUT+HARQ_RTT). Taking the following parameters: BW=180 Mbps ARQ_RTT=20 ms ARQ_ERROR_DETECTION_TIMEOUT=30 ms HARQ_RTT=5 ms, the transmitter needs to buffer ˜1210 KB to maintain maximum throughput in the depicted scenario.

The ARQ_ERROR_DETECTION_TIMEOUT 230 is used to prevent unnecessary ARQ retransmissions due to reordering by the HARQ mechanism (since blocks may be received out-of-order). The receiver is supposed to allow the HARQ mechanism enough time for retransmissions before declaring an error on a block and sending NACK to the transmitter.

Embodiments of the present invention provide a different mechanism to prevent unnecessary ARQ retransmissions. It does not necessarily require an ARQ_ERROR_DETECTION_TIMEOUT 230 in the receiver. The receiver can send its updated feedback any time and use the currently defined feedback information element (IE) to indicate which blocks arrived and which did not arrive yet (using the ACK feedback bitmap). Another embodiment could use a different feedback information element, in which a block's status is indicated as either received (ACKed), missing (NACKed) or not known yet.

Embodiments of the present invention may differ from existing techniques in the interpretation of the feedback in the transmitter when the same feedback information element is used. Instead of assuming that every bit in the feedback bitmap which is set to zero is actually a NACK, whenever such a feedback arrives, it just assumes that these blocks did not arrive yet. The blocks themselves are considered in error and retransmitted only when such feedback (with zero bits in the bitmap) arrives after the HARQ channel on which they were transmitted is used to transmit other data (i.e., Al_SN is flipped) or when the HARQ feedback on the final transmission attempt is a NACK. The meta-data for each outstanding block must include the HARQ channel identifier (ACID) on which it was sent for this mechanism to operate correctly.

If a different feedback information element is used, in which each block is either ACKed, NACKed or UNKNOWN, there is no need to include the HARQ ACID in the meta-data for each outstanding block.

Benefits of embodiments of the present invention are the transmitter can purge correctly received ARQ blocks much sooner than currently defined in the 802.16m D3 text in all scenarios (unless the receiver delays feedback for any reason, such as ACK aggregation). In the example above, the receiver will not delay its feedbacks (no ARQ_ERROR_DETECTION_TIMEOUT), and the transmitter will be able to remove the correctly received blocks ARQ_RTT time after they are sent. The only blocks which will have to be buffered longer in the transmit buffer are the blocks which were not received correctly, which in this case are the blocks sent in the first transmission 225. This is illustrated in FIG. 3, generally shown as 300. In this figure, T_{FB} 330 is the time it takes for the feedback to be transmitted by the ARQ receiver 310 and received and parsed by the ARQ transmitter 320.

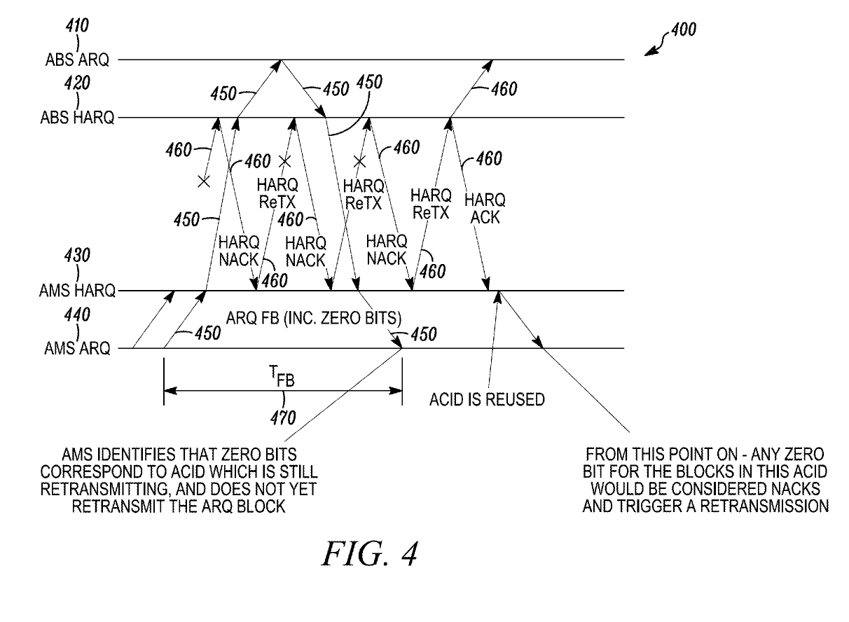

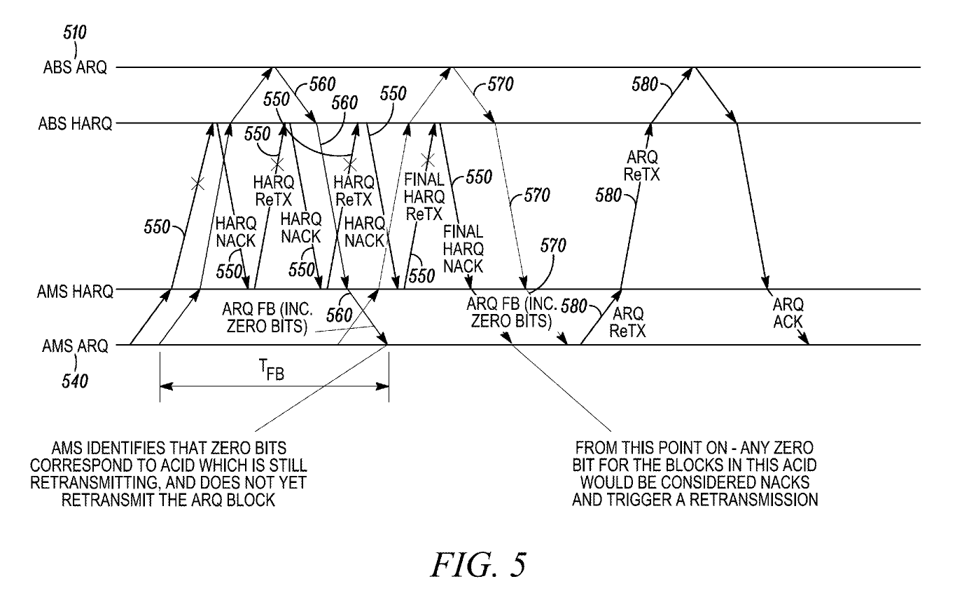

For a better understanding of the alternative method of interpreting the feedback, the following FIGS. 4-5 illustrate what happens assuming no HARQ feedback errors. FIG. 4 at 400 depicts what happens when the HARQ retransmissions finally succeed and how the suggested method is used to avoid unnecessary ARQ retransmissions. AMS ARQ is shown at 440, AMS HARQ at 430, ABS HARQ at 420 and ABS ARQ at 410. FIG. 5 at 500 explains what happens when the HARQ retransmissions fail and how the ARQ retransmission is triggered.

In FIG. 4, the ARQ blocks symbolized by the arrows shown as 450, are correctly received by the ABS ARQ receiver which can send its feedback immediately. This feedback would include zero bits in the bitmap, since the ARQ blocks sent in the bursts shown as 460 were lost and did not arrive yet. This feedback is received by the AMS ARQ transmitter, but since the ARQ transmitter is aware that the HARQ did not fail on the relevant ACID yet, it does not trigger a retransmission. T_{FB} is shown at 470. Another option is that the receiver would explicitly indicate that the missing blocks are probably still being retransmitted in the HARQ layer, since a timer has not yet expired counting from the instant the missing blocks have been detected (by detecting that the received ARQ block sequence number are out of order). After such a timer expires these blocks would be signaled as missing (NACKed), thus requesting the ARQ transmitter to retransmit them.

FIG. 5 at 500 shows generally how the suggested method handles HARQ failures and triggers ARQ retransmissions. AMS ARQ is shown at 540, AMS HARQ at 530, ABS HARQ at 520 and ABS ARQ at 510. The feedback, shown as 560, includes zero bits that are ignored in the ARQ transmitter, since the HARQ channel, shown as 550, is still retransmitting. When the feedback shown at 570 arrives, the HARQ channel 550 has exhausted its retransmissions and the ARQ transmitter treats the zero bits in the feedback 570 as NACKs which trigger the retransmission 580 of the missing ARQ blocks.

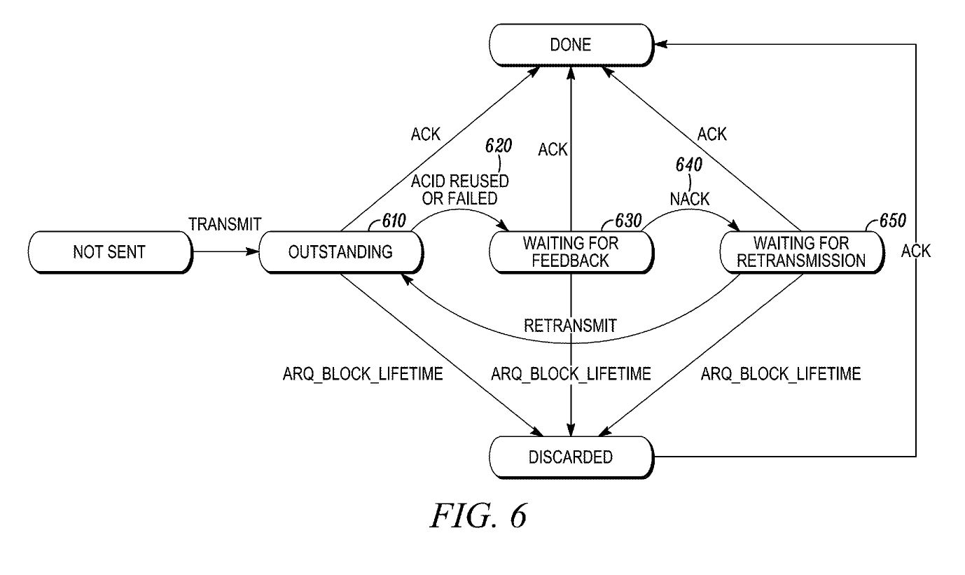

The state machine for each ARQ block would have to be revised to support this method as seen in FIG. 6 at 600. In this figure, while the ARQ block is in Outstanding state 610, meaning that the block have been transmitter and no feedback has been received for it yet, the only feedback that can change its state is a positive ACK (a “1” in the feedback bitmap). Zeros (“0”) in the feedback that correspond to the block are ignored at this state. Once the ARQ transmitter establishes that the ACID originally used to transmit the block has been reused to send something else, or that the ACID failed delivering the block, the “ACID reused or failed” 620 is signaled so that the block's state is changed to Waiting-for-Feedback 630. At this state, a feedback which indicates a “0” in the bitmap bit that corresponds to the block is interpreted as NACK 640 which would change the block's state to Waiting-for-retransmission 650 until the actual transmission occurs (or the ARQ_BLOCK_LIFETIME expires, or an ACK on the block is received).

The benefits of the alternative feedback methods provided by embodiments of the present invention include: • Support for all error conditions with a very small buffer which is proportional to ARQ_RTT * BW only (for the assumptions above −440 KB); • Minimal or no additional meta-data per ARQ block (in case local-NACKs are used); • Seamless integration with the ARQ-HARQ interaction mechanisms; • No need for ARQ_ERROR_DETECTION_TIMEOUT per missing SN in the receiver; • Faster retransmission of missing blocks in case of NACK→ACK errors

In another application and embodiments of the present invention, the ARQ_ERROR_DETECTION_TIMEOUT can be used, but a new type of feedback IE is required to signal only positive ACK without any NACK information when errors are suspected at the receiver. This is an explicit method of avoiding NACKs in the feedback rather than the implicit method suggested above. It does not mandate a change to the ARQ block state machine, but it lacks some of the benefits listed above, namely, when HARQ feedback errors occur the ARQ retransmission is still delayed by the ARQ_ERROR_DETECTION_TIMEOUT (last bullet in the list above).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a base station with a transceiver operable to communicate with a mobile station (MS) in a wireless network and adapted to provide ARQ Feedback to said MS enabling an efficient transmitter buffer usage by said transceiver sending its updated feedback any time and using a currently defined feedback IE to indicate which blocks arrived at said transceiver and which did not arrive yet.

2. The apparatus of claim 1, further comprising using an ACK feedback bitmap to indicate which blocks arrived at said transceiver and which did not arrive yet.

3. The apparatus of claim 2, wherein in an interpretation of feedback in said transceiver, instead of assuming that every bit in said feedback bitmap which is set to zero is actually a NACK, whenever such a feedback arrives, said transceiver assumes that blocks did not arrive yet and said blocks themselves are considered in error and retransmitted only when such feedback, with zero bits in said bitmap, arrives after an HARQ channel on which they were transmitted is used to transmit other data or when HARQ feedback on a final transmission attempt is a NACK.

4. The apparatus of claim 3, wherein meta-data for each outstanding block must include said HARQ channel on which it was sent.

5. The apparatus of claim 4, wherein said transceiver is adapted to purge correctly received ARQ blocks unless a receiver delays feedback for any reason, including ACK aggregation.

6. The apparatus of claim 1, wherein an ARQ_ERROR_DETECTION_TIMEOUT is used and a feedback IE is required to signal only positive ACK without any NACK information when errors are suspected at the receiver.

7. The apparatus of claim 6, wherein said transceiver avoids NACKs in feedback and does not mandate a change to an ARQ block state machine.

8. An apparatus, comprising:
a mobile station (MS) including a transceiver operable to communication with a base station (BS) in a wireless network, said BS includes a transceiver adapted to provide ARQ Feedback to said MS enabling an efficient transmitter buffer usage by said BS transceiver sending its updated feedback any time and using a currently defined feedback IE to indicate which blocks arrived at said BS transceiver and which did not arrive yet.

9. The apparatus of claim 8, further comprising said BS using an ACK feedback bitmap to indicate which blocks arrived at said BS transceiver and which did not arrive yet.

10. The apparatus of claim 9, wherein in an interpretation of feedback in said BS transceiver, instead of assuming that every bit in said feedback bitmap which is set to zero is actually a NACK, whenever such a feedback arrives, said BS transceiver assumes that blocks did not arrive yet and said blocks themselves are considered in error and retransmitted only when such feedback, with zero bits in said bitmap, arrives after an HARQ channel on which they were transmitted is used to transmit other data or when HARQ feedback on a final transmission attempt is a NACK.

11. The apparatus of claim 10, wherein meta-data for each outstanding block must include said HARQ channel on which it was sent.

12. The apparatus of claim 11, wherein said BS transceiver is adapted to purge correctly received ARQ blocks unless a receiver delays feedback for any reason, including ACK aggregation.

13. The apparatus of claim 8, wherein an
ARQ_ERROR_DETECTION_TIMEOUT is used and a feedback IE is required to signal only positive ACK without any NACK information when errors are suspected at said BS receiver.

14. The apparatus of claim 12, wherein said BS transceiver avoids NACKs in feedback and does not mandate a change to an ARQ block state machine.

15. A system, comprising:
a mobile station (MS);
a base station with a transceiver operable to communicate with said MS in a wireless network and adapted to provide ARQ Feedback to said MS enabling an efficient transmitter buffer usage by said transceiver sending its updated feedback any time and using a currently defined feedback IE to indicate which blocks arrived at said transceiver and which did not arrive yet.

16. The system of claim 15, said transceiver using an ACK feedback bitmap to indicate which blocks arrived at said transceiver and which did not arrive yet.

17. The system of claim 16, wherein in an interpretation of feedback in said transceiver, instead of assuming that every bit in said feedback bitmap which is set to zero is actually a NACK, whenever such a feedback arrives, said transceiver assumes that blocks did not arrive yet and said blocks themselves are considered in error and retransmitted only when such feedback, with zero bits in said bitmap, arrives after an HARQ channel on which they were transmitted is used to transmit other data or when HARQ feedback on a final transmission attempt is a NACK.

18. The system of claim 17, wherein meta-data for each outstanding block must include said HARQ channel on which it was sent.

19. A method of ARQ feedback for efficient transmitter buffer usage, comprising:
operating a base station (BS) with a transceiver to communicate with a mobile station (MS) in a wireless network and adapting said BS to provide ARQ Feedback to said MS enabling an efficient transmitter buffer usage by said transceiver sending its updated feedback any time and using a currently defined feedback IE to indicate which blocks arrived at said transceiver and which did not arrive yet.

20. The method of claim 19, further comprising using an ACK feedback bitmap to indicate which blocks arrived at said transceiver and which did not arrive yet.

21. The method of claim 20, wherein in an interpretation of feedback in said transceiver, instead of assuming that every bit in said feedback bitmap which is set to zero is actually a NACK, whenever such a feedback arrives, said transceiver assumes that blocks did not arrive yet and said blocks themselves are considered in error and retransmitted only when such feedback, with zero bits in said bitmap, arrives after an HARQ channel on which they were transmitted is used to transmit other data or when HARQ feedback on a final transmission attempt is a NACK.

22. The method of claim 21, wherein meta-data for each outstanding block must include said HARQ channel on which it was sent.

23. The method of claim 22, wherein said transceiver is adapted to purge correctly received ARQ blocks unless a receiver delays feedback for any reason, including ACK aggregation.

24. An apparatus, comprising:
a mobile station (MS) operable to transmit to a base station (BS) in a wireless network and adapted to use a modified feedback information element (IE), wherein said MS explicitly signals to said BS whether each block is ACKed, NACKed, or no feedback is provided for it.

25. The apparatus of claim 24, wherein said MS uses
ARQ_ERROR_DETECTION_TIMEOUT and meta-data saved per block and an ARQ transmitter does not have to be altered.

26. The apparatus of claim 25, wherein a state machine associated with said MS is thus capable of staying unchanged.

27. The apparatus of claim 26, wherein ACKs are thus sent earlier thereby reducing buffer occupancy.

28. An apparatus, comprising:
a base station (BS) operable to transmit to a mobile station (MS) in a wireless network and adapted to use a modified feedback information element (IE), wherein said BS explicitly signals to said MS whether each block is ACKed, NACKed, or no feedback is provided for it.

29. The apparatus of claim 24, wherein said BS uses
ARQ_ERROR_DETECTION_TIMEOUT and meta-data saved per block in and an ARQ transmitter does not have to be altered.

30. The apparatus of claim 25, wherein a state machine associated with said BS is thus capable of staying unchanged.

31. The apparatus of claim 26, wherein ACKS are thus sent earlier thereby reducing buffer occupancy.
